(19) United States
(12) Patent Application Publication
(10) Pub. No.: US 2015/0030729 A1
(43) Pub. Date: Jan. 29, 2015

(54) Method and Apparatus for Degassing an Infant Beverage

(71) Applicant: John David Hopkins, Boise, ID (US)

(72) Inventor: John David Hopkins, Boise, ID (US)

(21) Appl. No.: 13/952,619

(22) Filed: Jul. 28, 2013

(51) Int. Cl. A23L 2/76; B01D 19/02; A23L 1/29; B01D 19/00

(52) U.S. Cl. CPC A23L 2/76; B01D 19/0078; B01D 19/02; A23L 1/296; A23V 2002/00
USPC 426/238; 96/175

(57) ABSTRACT

A method and apparatus for degassing an infant beverage are disclosed. A method for degassing an infant beverage applies ultrasonic energy to said infant beverage to remove gases dissolved therein. An apparatus for degassing an infant beverage includes a container for receiving an infant beverage defined by an inner wall and a base, a container for receiving an infant beverage, and an ultrasonic energy source positioned to transmit ultrasonic energy into the container and into the infant beverage received in the container to remove gases dissolved in said infant beverage. A medium for transduction of the ultrasonic signal may be arranged between a bottle in which an infant beverage is received and the inner wall of the container. A heater may be coupled to the container to heat or maintain the infant beverage at an optimal temperature while said infant beverage is received in said container.

### TECHNICAL FIELD

The present embodiments relate generally to infant beverage preparation.

### BACKGROUND

The ingestion of gas by an infant during bottle feeding can result in significant digestive tract discomfort because infants may lack the ability to expel the gas contained in their stomachs after feeding and can cause the infant discomfort. If gas ingestion occurs such as gas dissolved in infant formula, the infant may experience discomfort due to the pressure buildup in their digestive systems caused by the ingested gas. If the infant does not expel the ingested gas from their stomachs shortly after feeding, the gas will travel further down the digestive tract resulting in prolonged discomfort.

To enable the infant to expel the ingested gas and relieve the pressure buildup and associated digestive tract discomfort, parents typically hold the infant upright and gently pat the infant's back after bottle feeding to promote burping. Methods to apply counter pressure to the infant's belly can also aid the infant in expulsion of the gas such as gently leaning the infant's belly against the parents torso followed by gently patting the infant's back. Infants that expel the gas on their own or while aided by parents are generally more comfortable than infants who will retain the ingested gas as it passes through their digestive tracts.

Improved infant comfort by the reduction of gas pressure in the infant's digestive system has several benefits as comfortable infants tend to function better including getting higher quality sleep and for longer durations, as well as eating higher quantities of food at more predictable intervals because feeding is not associated with pain by the infant. More comfortable infants also exhibit reduced fussiness and improved mood and happiness resulting in more social interaction and accelerated learning and development as they are not distracted by digestive tract pain.

The preparation of infant beverage such as formula can be a cause of gas ingestion by the infant as gas becomes dissolved in the formula mixture. Formula preparation requires mixing of dry powdered formula into warm water to obtain a complete homogenous solution which is typically accomplished by adding formula powder to water contained in a bottle and stirring the mixture or shaking the bottle. Methods of mixing such as shaking or stirring the infant formula causes gas to be dissolved into the formula mixture or creates foam on top which is undesirable due to the potential to cause digestive discomfort when the formula mixture and dissolved gas and foam are ingested by the infant. Prior to feeding and during infant beverage preparation, it is desirable to remove as much gas as possible from the mixture to avoid ingestion by the infant and to reduce or eliminate the resulting discomfort associated with gas ingestion.

### OBJECT OF THE INVENTION

An object of the invention is to provide an apparatus to remove gas from an infant beverage such as an infant formula mixture so as to reduce the amount of gas subsequently ingested by the infant.

A further object of the invention is to provide an apparatus that can maintain an infant beverage at an optimized temperature during the degassing and beverage preparation process.

An additional object of the invention is to provide a method to remove gas from an infant beverage to reduce the amount of gas subsequently ingested by the infant.

Still another object of the invention is to provide an apparatus having a container in which an infant beverage is mixed and prepared.

A further object of the invention is to provide an apparatus that aids in the mixing of an infant beverage to obtain a more complete homogenous solution.

Another object of the invention is to provide an apparatus that removes foam from an infant beverage.

### SUMMARY OF THE INVENTION

In accordance with the present invention, an apparatus is provided for degassing an infant beverage including: a container defined by an inner wall for receiving an infant beverage, a bottle containing an infant beverage may be received in the container, and an ultrasonic energy source positioned to transmit ultrasonic energy into the container in which an infant beverage is received, said infant beverage being either received in the bottle or received directly in the container, said ultrasonic energy is applied to remove gas or foam from said infant beverage so as to prevent ingestion of gas by the infant.

A medium facilitating the transduction of ultrasonic energy from the ultrasonic energy source and ultimately into the infant beverage such as water may be arranged between the bottle in which an infant beverage is received and the inner wall of the container. The infant beverage such as the unmixed components of infant formula or a more complete homogenous infant formula may be placed directly within the container in the absence of a medium facilitating the transduction of ultrasonic energy. A heater may be positioned to apply heat to the container for heating or maintaining the temperature of the infant beverage contained in the bottle or contained directly in the container.

In one embodiment, the container wherein a bottle holding a beverage is received is preferably capable of holding a medium for transduction of the ultrasonic energy transmitted by the ultrasonic source into the beverage.

In another embodiment, the ultrasonic source is positioned in direct contact with the bottle wherein the infant beverage is received without requiring a medium facilitating the transduction of ultrasonic energy.

In an additional embodiment, the infant beverage is either mixed within or transferred to the container after mixing. The ultrasonic energy source is transmitted into the container and directly into the infant beverage. Direct contact of the infant beverage with the container into which ultrasonic energy is being transmitted allows for more efficient degassing and optimal heating of the infant formula in the case that a heater is used in conjunction with an ultrasonic energy source. In the embodiment described, the infant formula can either be mixed prior to being transferred into the container or mixed within the container.

A preferred embodiment of the invention includes an ultrasonic energy source disposed inside or in contact with a container, said ultrasonic source is capable of transmitting ultrasonic energy into said container, said container is capable of receiving an infant beverage or formula in such a way as to allow transmission of the ultrasonic energy into said infant beverage or formula either directly or indirectly by means of a medium for the transduction of ultrasonic energy, such as water, and transmitted through the wall of the bottle in which the infant beverage or formula is received. In this preferred embodiment, the infant beverage or formula may be received within a bottle, said bottle containing the infant beverage or formula is placed within said container and ultrasonic energy is transmitted through the wall of the bottle and into the infant beverage or infant formula. Transmission of the ultrasonic energy preferably occurs through the wall of the container and into an ultrasonic energy transmission medium held in the container such as water, said ultrasonic energy transmission medium is capable of transmitting ultrasonic energy through both the container wall and the bottle wall in which an infant beverage is received, said ultrasonic energy is transmitted into the infant beverage or formula received within the bottle to remove dissolved gas.

In another embodiment, the infant beverage or formula is mixed within the container either mechanically or by means of acoustic streaming caused by the application of ultrasonic energy to the infant beverage which mixes the beverage by creating localized regions of turbulence within the infant beverage. In this embodiment, the formula is mixed while maintaining direct contact with the inner wall of the container allowing both mixing and degassing simultaneously by means of the ultrasonic energy. Direct contact of the beverage or formula with the inner wall of the container through which ultrasonic energy is being transmitted is preferred to maximize the degassing efficiency as no ultrasonic energy is lost as in the case that ultrasonic energy is transmitted through a bottle wall.

### BRIEF DESCRIPTION OF THE DRAWINGS

FIG. 1 is a perspective view of an infant beverage degassing apparatus in accordance with the present invention, in which a portion of the apparatus has been cut off for showing an inner structure or configuration of said apparatus:

FIG. 2 is a cross sectional view of an infant beverage degassing apparatus;

FIG. 3 is a cross sectional view similar to FIG. 2, illustrating the operation of an infant beverage degassing apparatus in which a bottle containing an infant beverage is placed within the container;

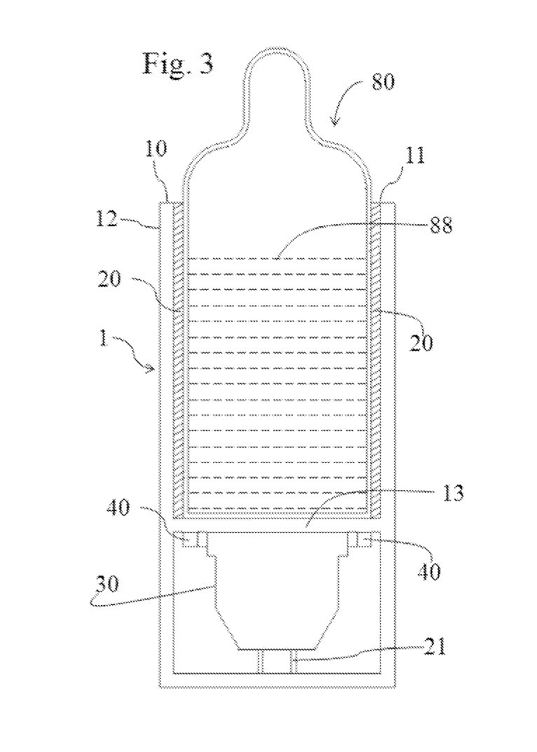

FIG. 4 is a cross sectional view similar to FIG. 2, illustrating the operation of an infant beverage degassing apparatus in which the infant beverage is held directly within the container in direct contact with the inner peripheral wall;

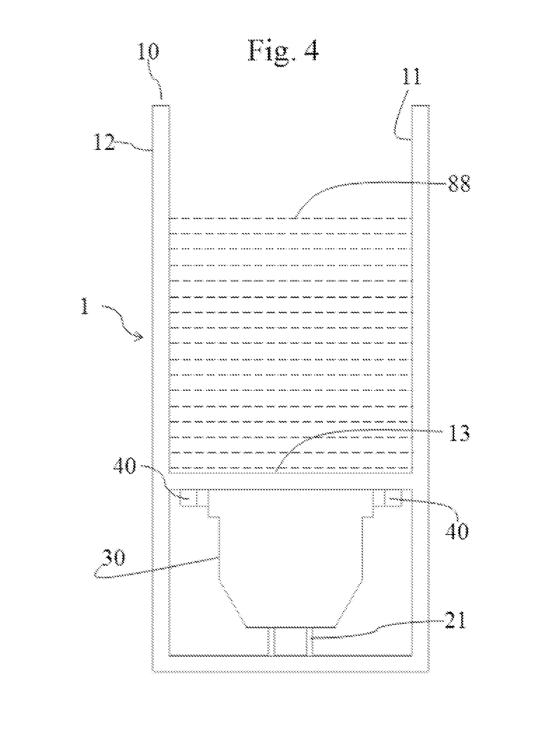

FIG. 5 is a perspective view illustrating the simplified arrangement of an infant beverage degassing apparatus in which an infant beverage is held directly within the container.

### DETAILED DESCRIPTION

In the following detailed description, reference is made to the accompanying drawings that form a part hereof and in which are shown, by way of illustration, specific embodiments. In the drawings, like numerals describe substantially similar components throughout the several views. Other embodiments may be utilized and structural, logical, and electrical changes may be made without departing from the scope of the present disclosure. The following detailed description is, therefore, not to be taken in a limiting sense.

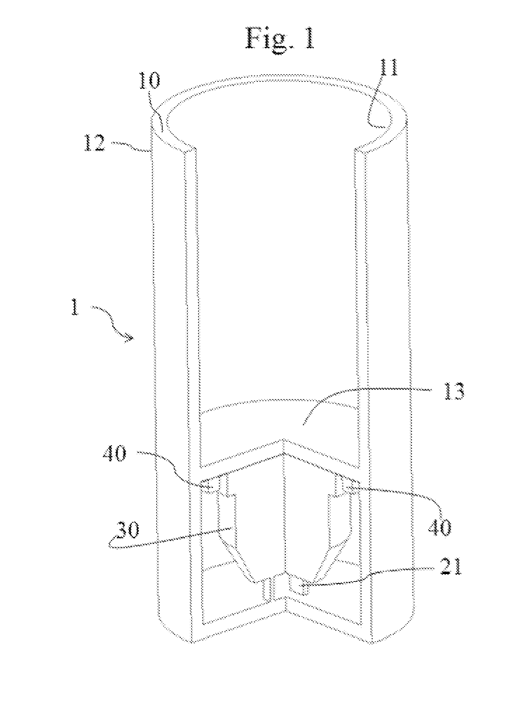

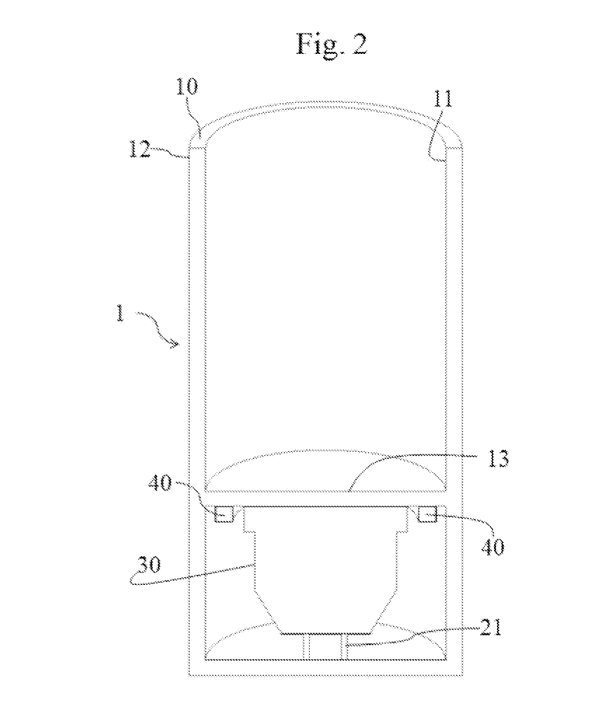

Referring to the drawings, and initially to FIGS. 1 and 2, an infant beverage degassing apparatus 1 in accordance with the present invention comprises a degassing container 10 defined by an inner peripheral wall 11 and an outer peripheral wall 12 and a base 13 for receiving a medium facilitating the transduction of ultrasonic energy 20, such as water 20 therein, and for receiving a bottle 80 therein in which the bottle 80 is provided for receiving an infant beverage 88 or unmixed or partially mixed components of an infant beverage 88 therein, such as infant formula powder, water, or other liquid products or the like, or the bottle 80 may be selected from various bottled infant beverages. The medium for the transduction of ultrasonic energy 20 is thus disposed or arranged between the bottle 80 and the inner peripheral wall 11 of the degassing container 10.

An ultrasonic energy source 30 is positioned so as to transmit ultrasonic energy into the container 10, such as positioned in contact with the base 13 of the container 10, for generating and transmitting ultrasonic energy into the infant beverage 88 received in the bottle 80 so as to remove gas from the infant beverage 88. The frequency of the ultrasonic energy may be in a range from 20 kHz to 1000 kHz, and preferably ranged from 20 to 150 kHz, said ultrasonic energy may be applied to drive gas out of the infant beverage 88 indirectly such as via the medium for the transduction of ultrasonic energy 20, or directly without the medium for the transduction of ultrasonic energy 20 in which the infant beverage 88 is disposed directly in the container 10. The ultrasonic energy source 30 may be directly or indirectly such as by means of electrical circuitry connected to various electric power sources including an electrical outlet or battery via one or more electric connections 21.

The base 13 of the container 10 may be formed by the upper surface of the ultrasonic energy source 30 so as to allow direct transduction of the ultrasonic energy into the infant beverage to improve the degassing efficiency thereof.

A heater 40 positioned for heating the infant beverage 88 received in the bottle 80, either indirectly via the medium for the transduction of ultrasonic energy 20 or directly in the case that the infant beverage is placed directly within the container 10 and in direct contact with the inner peripheral wall 11 of the container 10.

In operation, the container 10 for receiving an infant beverage 88 that has been prepared or mixed in the bottle 80 prior to being placed in the container or prepared or mixed directly within the container 10 such that the infant beverage 88 may also heated or degassed or mixed by either or both the heater 40 and the ultrasonic energy source 30 of the infant beverage degassing apparatus 1 in accordance with the present invention.

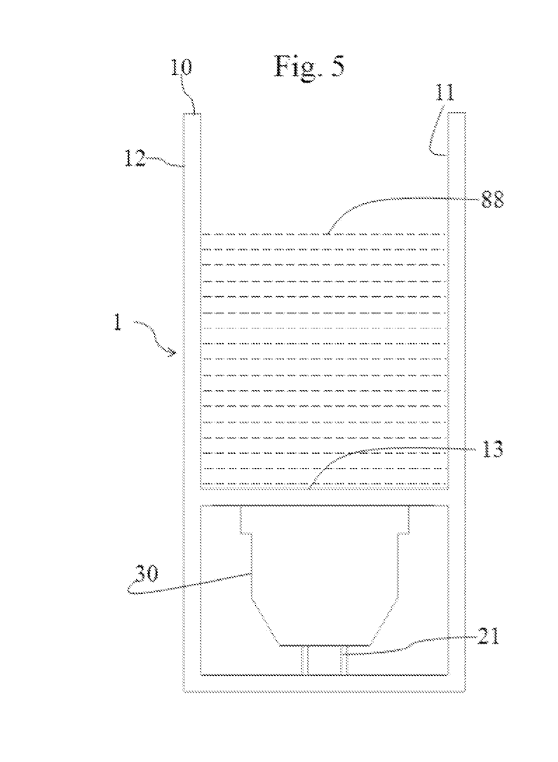

Alternatively, as shown in FIG. 5, in which the heater 40 has been removed, the ultrasonic energy source 30 is used to heat, degas, and mix the infant beverage 88 using only the ultrasonic energy produced by the ultrasonic energy source 30 of the infant beverage degassing apparatus 1 indirectly such as said infant beverage being placed in a bottle or directly such as said infant beverage being placed directly in the container 10 via the medium for the transduction of ultrasonic energy 20.

Accordingly, the infant beverage degassing apparatus 1 in accordance with the present invention may be provided for degassing the infant beverage 88, and includes a heating device 40 for maintaining the infant beverage at an optimal temperature.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

What is claimed is:

1. An infant beverage degassing apparatus comprising: a container for receiving an infant beverage, said container defined by an inner wall and a base, a medium for the transduction of ultrasonic energy received in said container, said medium for the transduction of ultrasonic energy being water, and an ultrasonic energy source in contact with said container for transmitting ultrasonic energy into said container the frequency of said ultrasonic energy being in the range from 20 kHz to 1000 kHz.

2. The apparatus of claim 1, further comprising a heater coupled to said container for maintaining said infant beverage at an optimal temperature while said infant beverage is received in said container.

3. A method for removing gas from an infant beverage, the method comprising:
providing an infant beverage degassing apparatus having a container for receiving an infant beverage in contact with an ultrasonic energy source;
providing an infant beverage received in said container; and
applying ultrasonic energy produced by said ultrasonic energy source to said infant beverage so as to remove gas from said infant beverage.
